(19) United States
(12) Patent Application Publication
(10) Pub. No.: US 2017/0301939 A1
(43) Pub. Date: Oct. 19, 2017

(54) FUEL CELL SYSTEM WITH COMBINED PASSIVE AND ACTIVE SORBENT BEDS

(71) Applicant: LG Fuel Cell Systems, Inc., North Canton, OH (US)

(72) Inventors: Anant K. Upadhyayula, Stow, OH (US); Greg C. Rush, Canton, OH (US); Mark Anthony Perna, Alliance, OH (US); Mark Vincent Scotto, Uniontown, OH (US); Cris DeBellis, North Canton, OH (US); John R. Budge, Beachwood, OH (US)

(21) Appl. No.: 15/486,974

(22) Filed: Apr. 13, 2017

Related U.S. Application Data
(60) Provisional application No. 62/322,065, filed on Apr. 13, 2016.

(51) Int. Cl. H01M 8/0662; H01M 8/0612; H01M 8/04007; B01J 8/02; B01D 53/04; C10L 3/10; H01M 8/04014; H01M 8/124

(52) U.S. Cl. CPC H01M 8/0675; C10L 3/103; H01M 8/0618; H01M 8/04014; H01M 8/04037; B01J 8/02; B01D 53/0446; B01D 2256/24; B01D 2257/302; B01D 2257/304; B01D 2257/306; C10L 2290/542; H01M 2008/1293; B01J 2208/02

(57) ABSTRACT

A fuel cell system including a hydrocarbon fuel stream including a sulfur compound; a passive sorbent bed including a selective sulfur sorbent configured to remove the sulfur compound from the hydrocarbon fuel stream; a SCSO reactor, and an active sorbent bed comprising a sulfur oxide sorbent, wherein the active sorbet bed is configured to receive an effluent stream from the SCSO reactor and remove at least a portion of the sulfur oxides via the sulfur oxide sorbent. During start-up of the fuel cell system, the hydrocarbon fuel stream may be directed along a first flow pathway through the passive sorbent bed to remove the sulfur compound from the fuel stream during a first time period and then directed along a second flow pathway during a second time period that does not pass through the passive sorbent bed, e.g., once the SCSO reactor/active sorbent bed have reached operating temperature.

This application claims the benefit of U.S. Provisional Application No. 62/322,065, filed Apr. 13, 2016, which is incorporated herein by reference in its entirety.

### TECHNICAL FIELD

The disclosure generally relates to desulfurizer subsystems in fuel cell systems.

### BACKGROUND

Fuel cell systems, and associated desulfurization subsystems that reduce the total sulfur content of hydrocarbon fuels, remain an area of interest. Some existing systems have various shortcomings, drawbacks, and disadvantages relative to certain applications. Accordingly, there remains a need for further contributions in this area of technology.

### SUMMARY

In some examples, the disclosure relates to fuel cell systems, such as, e.g., solid oxide fuel cell systems, that employ one or more desulfurizer sub-systems to remove sulfur compounds from a hydrocarbon fuel stream such as natural gas, e.g., prior to the hydrocarbon fuel stream being delivered to a fuel cell stack for use as a fuel source. Example systems may include a desulfurizer sub-system that employs both a passive sorbent bed to remove sulfur compounds from a hydrocarbon fuel stream in conjunction with an active sorbent bed and a selective catalytic sulfur oxidation (SCSO) reactor. The fuel stream may be selectively directed to one or both of the active sorbent bed and passive sorbent bed, e.g., depending on the operating condition of the fuel cell system. For example, during start-up of the system, the hydrocarbon fuel stream may be supplied along a first flow path to the passive sorbent bed for removal of sulfur compound(s) from the stream but not to the active sorbent bed, e.g., while the SCSO reactor and active sorbent bed heat up. Once the SCSO reactor and active sorbent bed reach a desired operating temperature, the fuel stream may be directed to bypass the passive sorbent and supplied to the SCSO reactor and active sorbent bed along a second flow path for removal of sulfur compounds. In some examples, the SCSO reactor and active sorbent bed may be used at the same time as the passive sorbent bed to remove sulfur compounds from a fuel stream, e.g., in series or parallel with each other. The desulfurized fuel stream may be used as needed within the fuel cell system, e.g., by being supplied to the anode/fuel side of a fuel cell stack.

In one example, the disclosure relates to a fuel cell system comprising a hydrocarbon fuel stream comprising a sulfur compound; a passive sorbent bed comprising at least one selective sulfur sorbent configured to remove the sulfur compound from the hydrocarbon fuel stream to form a first desulfurized hydrocarbon stream, wherein the system is configured such that the hydrocarbon fuel stream passes through the passive sorbent bed along a first flow pathway and does not pass through the passive sorbent bed along a second flow pathway, wherein the system is configured such that the hydrocarbon fuel stream is selectively directed along at least one of the first flow pathway or the second flow pathway; an oxidant stream, wherein the system is configured such that the oxidant stream mixes with at least one of the hydrocarbon fuel stream from the second flow pathway or the first desulfurized hydrocarbon stream from the first flow pathway; a heating module configured to heat the mixed oxidant and at least one of the hydrocarbon fuel and first desulfurized hydrocarbon streams to a temperature greater than about 150 degrees Celsius; a selective catalytic sulfur oxidation (SCSO) reactor comprising an at least one sulfur oxidation catalyst, wherein the selective catalytic sulfur oxidation reactor is configured to receive and contact the heated mixture of the oxidant stream and the at least one of the hydrocarbon fuel stream or the first desulfurized hydrocarbon fuel stream with the at least one sulfur oxidation catalyst, wherein the at least one sulfur oxidation catalyst is configured to oxidize at least one sulfur-containing compound in the received stream to form an SCSO effluent stream including sulfur oxides; an active sorbent bed comprising a sulfur oxide sorbent, wherein the active sorbet bed is configured to receive the SCSO effluent stream from the SCSO reactor and remove at least a portion of the sulfur oxides via the sulfur oxide sorbent to form a second desulfurized hydrocarbon stream, and a solid oxide fuel cell including at least one electrochemical cell, wherein the solid oxide fuel cell is configured to receive at least a portion of the second desulfurized hydrocarbon stream as a fuel source.

In another example, the disclosure is directed to a method for operating a fuel cell system comprising a hydrocarbon fuel stream comprising a sulfur compound; a passive sorbent bed comprising at least one selective sulfur sorbent configured to remove the sulfur compound from the hydrocarbon fuel stream to form a first desulfurized hydrocarbon stream, wherein the system is configured such that the hydrocarbon fuel stream passes through the passive sorbent bed along a first flow pathway and does not pass through the passive sorbent bed along a second flow pathway, wherein the system is configured such that the hydrocarbon fuel stream is selectively directed along at least one of the first flow pathway or the second flow pathway; an oxidant stream, wherein the system is configured such that the oxidant stream mixes with at least one of the hydrocarbon fuel stream from the second flow pathway or the first desulfurized hydrocarbon stream from the first flow pathway; a heating module configured to heat the mixed oxidant and at least one of the hydrocarbon fuel and first desulfurized hydrocarbon streams to a temperature greater than about 150 degrees Celsius; a selective catalytic sulfur oxidation (SCSO) reactor comprising an at least one sulfur oxidation catalyst, wherein the selective catalytic sulfur oxidation reactor is configured to receive and contact the heated mixture of the oxidant stream and the at least one of the hydrocarbon fuel stream or the first desulfurized hydrocarbon fuel stream with the at least one sulfur oxidation catalyst, wherein the at least one sulfur oxidation catalyst is configured to oxidize at least one sulfur-containing compound in the received stream to form an SCSO effluent stream including sulfur oxides; an active sorbent bed comprising a sulfur oxide sorbent, wherein the active sorbet bed is configured to receive the SCSO effluent stream from the SCSO reactor and remove at least a portion of the sulfur oxides via the sulfur oxide sorbent to form a second desulfurized hydrocarbon stream, and a solid oxide fuel cell including at least one electrochemical cell, wherein the solid oxide fuel cell is configured to receive at least a portion of the second desulfurized hydrocarbon stream as a fuel source, the method comprising directing the hydrocarbon fuel stream along the first flow pathway during a first time period; and directing the hydrocarbon fuel stream along the second flow pathway during a second time period different from the first time period.

The details of one or more embodiments of the disclosure are set forth in the accompanying drawings and the description below. Other features, objects, and advantages of the disclosure will be apparent from the description and drawings, and from the claims.

### BRIEF DESCRIPTION OF DRAWINGS

The description herein makes reference to the accompanying drawings wherein like reference numerals refer to like parts throughout the several views.

FIG. 1 is a schematic diagram illustrating an example desulfurizer subsystem in a fuel cell system.

FIG. 2 is a schematic diagram illustrating another example desulfurizer subsystem in a fuel cell system.

FIG. 3 is a schematic diagram illustrating another example desulfurizer subsystem in a fuel cell system.

FIG. 4 is a flow diagram illustrating an example technique for operating a fuel cell system in accordance with one or more examples of the disclosure.

### DETAILED DESCRIPTION

Fuel cell systems, such as, e.g., solid oxide fuel cell systems, may be employed to generate electricity using one or more electrochemical cells. A hydrocarbon-containing feed stream, such as, e.g., a natural gas stream, may be used by the fuel cell system as a fuel source for the electrochemical cell. However, in some examples, the hydrocarbon-containing feed stream may also include organic and/or inorganic sulfur compounds, such as, e.g., hydrogen sulfide, which may be naturally occurring in natural gas, for example, or may be added as an odorant. Such sulfur compounds may poison the anode of an electrochemical cell of a fuel cell system, reducing efficiency and/or the life of the anode.

In some examples, a fuel cell system may include a desulfurization sub-system that is configured to remove sulfur from a hydrocarbon feed stream prior to being feed to the anode side of an electrochemical cell, e.g., via one or more separations processes. For example, a desulfurization sub-system may employ a selective catalyst sulfur oxidation (SCSO) reactor and active sorbent bed to remove at least a portion of sulfur in a hydrocarbon feed stream. The SCSO reactor may convert at least a portion of the sulfur in the hydrocarbon feed stream via a catalytic oxidation process to form one or more sulfur oxides. The active sorbent may receive the effluent stream from the SCSO reactor and remove the one or more sulfur oxides via a sulfur oxide sorbent. However, in such a set-up, the SCSO reactor may require a period of time (start-up time) to reach the elevated operating temperature. Similarly, the active sorbent bed may need to reach a minimum temperature before the bed removes a desirable amount of sulfur oxides from the SCSO reactor effluent stream. Additionally, the system may be required to shut down when maintenance to the SCSO reactor and/or active sorbent bed is needed.

In accordance with one or more examples of the disclosure, examples of the disclosure include fuel cell systems that may employ a passive sorbent bed in combination with an SCSO reactor and active sorbent bed in a desulfurization sub-system. As will be described in further detail herein, in such a configuration, the exothermic SCSO reactor may be used for heat-up of the active sorbent bed and thereby eliminate the need for a burner, blower and control functions which may alternatively be used to heat-up the active sorbent bed. During the heat-up of the SCSO reactor and active sorbent bed, a natural gas stream including sulfur compounds may be fed through the passive sorbent bed to desulfurize the natural gas stream. The desulfurized natural gas (DNG) from the passive sorbent bed may also be fed directly to the Fuel Cell Vessel (FCV) and other system components, providing an “instant-on” capability without having to wait for the SCSO sorbent bed to heat up. Once the active sorbent bed reaches operational temperature, all or a portion of the natural gas stream including sulfur compounds may be fed along a flow pathway that does not pass through the passive sorbent bed to the SCSO reactor and active sorbent bed to desulfurize the natural gas. The passive sorbent bed may be used in addition to or as an alternative to the SCSO reactor and active sorbent bed to remove sulfur from the natural gas stream and form a DNG stream, e.g., that is fed to the FCV as a fuel source. In some examples, the “instant-on” capability also allows maintenance to be carried out on the SCSO sub-system without having to disrupt the operation of the fuel cell system, e.g., by using the passive sorbent bed for desulfurization of the NG stream when the SCSO reactor and/or active sorbent bed are taken off line for maintenance during operation of the system rather than shutting down the system.

As will be described below, passive sorbents beds may employ passive sorbent(s) to remove substantially all or a portion of organic and/or inorganic sulfur compounds from a gas stream, e.g., a natural gas stream, based on the preferential physical adsorption of the sulfur compounds by the sorbent. Sorbents such as zeolites, metal impregnated carbons, and aluminas are examples of such passive sorbents. The relative simplicity of an approach using a passive sorbent bed to remove sulfur from a natural gas stream or other fuel stream may be advantageous because of the low capital investment and minimal control requirements. However, passive sorbents may have relatively low sulfur capacities and their effectiveness may be dependent on the sulfur species present and the presence of other competing species (e.g. H₂O) that can displace the adsorbed sulfur compounds. Examples of the present disclosure may combine the advantages of SCSO and passive sorbents to provide a more effective solution for managing, e.g., removing, sulfur compounds from one or more gas streams in a fuel cell system.

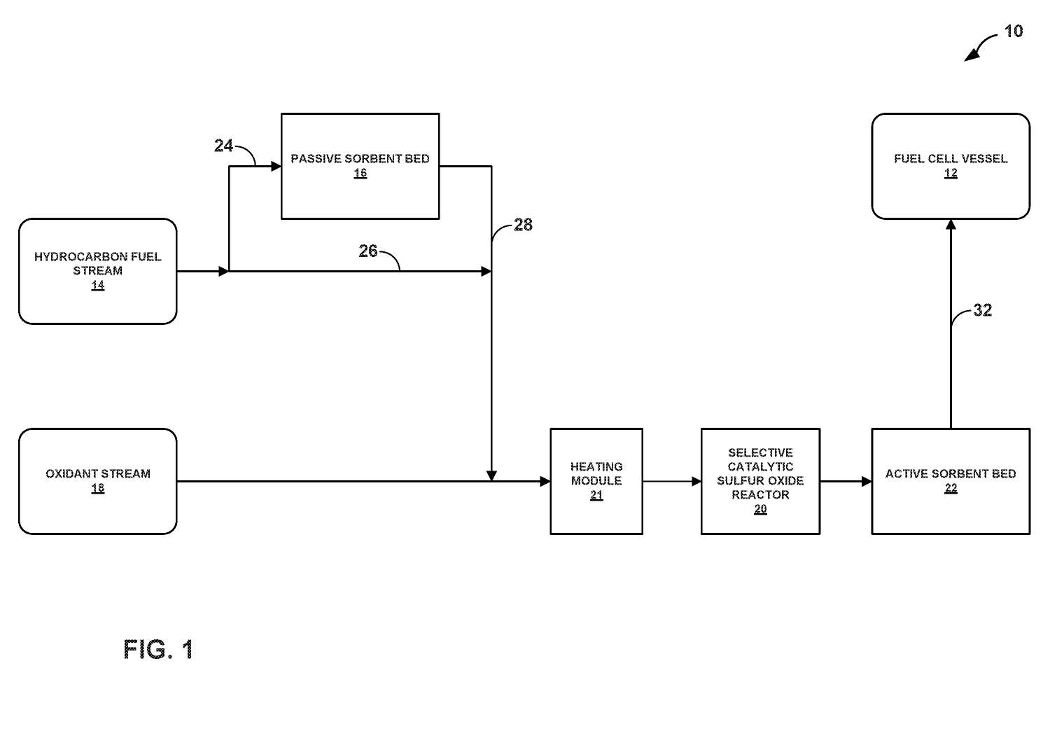

FIG. 1 is a simplified schematic diagram illustrating an example solid oxide fuel cell system 10 in accordance with an embodiment of the present disclosure. As shown, fuel cell system 10 includes fuel cell vessel (FCV) 12, hydrocarbon fuel stream 14, oxidant stream 18, passive sorbent bed 16, SCSO reactor 20, and active sorbent bed 22. Passive sorbent bed 16, SCSO reactor 20 and active sorbent bed 22 and FCV 12 are fluidly connected to each other according the flow paths illustrated in FIG. 1, such as, e.g., flow paths 24, 26, 28, and 32, using any suitable configuration, such as, e.g., suitable pipes, ducts, and the like.

Hydrocarbon fuel stream 14 may be a gas stream comprising hydrocarbon(s). For ease of description, hydrocarbon fuel stream 14 is primarily described herein in the context of a natural gas stream, although other suitable fuel streams are contemplated. These fuels include compressed natural gas (CNG), liquefied petroleum gas (LPG) or synthetic natural gas and fuel blends tailored to provide gas mixtures having desired heat contents.

Hydrocarbon fuel stream 14 may include methane, ethane, propane and other higher order hydrocarbons as well as carbon dioxide, nitrogen, oxygen and other components prior to being processed by passive sorbent bed 16 and/or SCSO reactor 20 and active sorbent bed 22. Additionally, hydrocarbon fuel stream 14 may include one or more organic and/or inorganic sulfur compounds, such as, e.g., H2S, COS, CS2, mercaptans, sulfides and thiophenes. Such sulfur components may be naturally present in available pipeline natural gas (PNG) streams or added as an odorant to address safety concerns. In some examples, hydrocarbon fuel stream 14 may include approximately 0.05 to approximately 200 parts per million-volume basis (ppm-V) sulfur or more. Natural gas may typically contain, for example, approximately 0.1 to approximately 10 ppm-V sulfur, while LPG may contain higher sulfur levels, for example, approximately 10 to approximately 170 ppm-V sulfur, prior to desulfurization in the manner described herein.

As noted above, the presence of sulfur within hydrocarbon fuel stream 14 may be detrimental to the operation of system 10. For example, sulfur may reduce the effectiveness of a steam reforming catalyst to convert all, or a portion of desulfurized fuel steam 14 to carbon monoxide and hydrogen in FCV-12. Further, sulfur negatively affects the electrochemical processes at the anode reducing fuel cell performance and the life of the fuel cell.

Passive sorbent bed 16 may be configured to desulfurize hydrocarbon fuel stream 14 by removing at least a portion of the organic and/or inorganic sulfur compounds present within fuel stream 14. For example, passive sorbent bed 16 may include a vessel containing one or more sorbent materials that adsorb the organic and/or inorganic sulfur compounds within fuel stream 14 when fuel stream 14 flows over the sorbent materials in passive sorbent bed 16. Examples of suitable sorbent materials for passive sorbent bed 16 include zeolites and metal impregnated carbons and aluminas. The selection of a particular sorbent material for sorbent bed 16 will also depend on the type of sulfur compounds in fuel stream 14. Some passive sorbents have high affinity for inorganic sulfur compounds while others preferentially adsorb organic sulfur compounds. Further, the presence of competing adsorbates in fuel stream 14, such as water, may reduce the adsorption capacity of the passive sorbent bed, depending on the sulfur compounds present. For example, bulky sulfur compounds such as diethyl sulfide and ethyl methyl sulfide are more weakly adsorbed and hence more readily displaced by competing adsorbates such as water. In some instances, it is advantageous to pass the fuel stream 14 through a desiccant bed to lower the moisture content of the gas and thereby increase the adsorption capacity of the passive sorbent bed.

In some examples, passive sorbent bed 16 may be designed to remove approximately 99% to approximately 99.99% of the sulfur compounds present within fuel stream 14. In some examples, passive sorbent bed 16 may be designed to remove an amount of sulfur compounds present within fuel stream 14 such that the outlet gas stream from passive sorbent bed 16 includes less than approximately 100 ppb-V sulfur, such as, e.g., less than approximately 50 ppb-V sulfur. Design considerations for passive sorbent bed 16 may include the gas hourly space velocity, the ratio of the diameter to the length of the sorbent bed, the temperature and operating pressure, the sorbent sulfur capacity and the average sulfur and moisture levels in fuel stream 14. Passive sorbent bed 16 may also comprise multiple sorbent beds connected in for example, a lead-lag configuration to improve the effective sulfur capacity of the beds and facilitate the change-out of sulfur-saturated passive sorbent.

Similarly, SCSO 20 and active sorbent bed 22 may additionally or alternatively desulfurize fuel stream 14 by removing at least a portion of the organic and/or inorganic sulfur compounds present within fuel stream 14. For example, SCSO reactor 20 may include one or more sulfur oxidation catalysts within a reactor vessel. SCSO reactor 20 may receive fuel stream 14 (which may be mixed with oxidant stream 14), and at least one sulfur oxidation catalyst may oxidize at least one sulfur-containing compound in the received stream to form an SCSO effluent stream including sulfur oxides. Example suitable sulfur oxidation catalysts are not particularly limited, so long as the composition can catalyze oxidation of sulfur compounds contained in the hydrocarbon feed to sulfur oxides under the prevailing reaction conditions. Preferred oxidation catalysts include, as the catalytically active component, a metal selected from Group VIII of the Periodic Table of the Elements, and or base metal oxides such as oxides of chromium, manganese, iron, cobalt, nickel, copper and zinc. More preferred catalysts for use in the process comprise a metal selected from palladium, platinum and rhodium, and/or base metal oxides such as oxides of iron, cobalt, and copper. Preferred catalysts comprise platinum and particularly preferred catalysts comprise platinum and iron.

The effluent stream including sulfur oxides from SCSO reactor 22 may then be supplied to active sorbent bed 22. Active sorbent bed 22 may include a vessel containing one or more sorbent materials that react with the sulfur oxides within the effluent stream, e.g., based on the reaction of a metal oxide with the sulfur oxides to give a metal sulfite or metal sulfate, when the effluent stream flows over the sorbent materials within the active sorbent bed 22. Example suitable sorbent materials are not particularly limited, so long as they are capable of reacting with sulfur oxides at the prevailing conditions; the sulfur oxide adsorbents preferably comprise alkali metal oxides, alkali earth metal oxides and/or base metal (Fe, Ni, Cu, Zn) oxides, which oxides are preferably supported on porous materials such as silica, alumina, etc.

Active sorbent bed 22 may be referred to as being “active” as the sorbents rely on reactive adsorption of a sulfur compound in a gas stream, where the sulfur compound (e.g., sulfur oxide) reacts with the active sulfur sorbent. Conversely, passive sorbent bed 16 may be referred as being “passive” as the sorbents in the bed rely on physical adsorption for the removal of sulfur compounds from a process stream.

In this manner, SCSO reactor 20 and active sorbent bed 22 may remove sulfur compounds from hydrocarbon fuel stream 14 to form a DNG stream like that of passive sorbent bed 16. In some examples, SCSO reactor 20/active sorbent bed 22 may be designed to remove approximately 99% to approximately 99.99% of the sulfur compounds present within fuel stream 14. In some examples, SCSO reactor 20/active sorbent bed 22 may be designed to remove an amount of sulfur compounds present within fuel stream 14 such that the outlet gas stream from SCSO reactor 20/active sorbent bed 22 includes less than approximately 100 ppb-V sulfur, such as, e.g., less than approximately 50 ppb-V sulfur. Design considerations for SCSO reactor 20/active sorbent bed 22 may include the gas hourly space velocity for the SCSO reactor, the gas hourly space velocity for the active sorbent bed, the temperature and operating pressure, the sulfur capacity of the active sorbent, the oxygen to hydrocarbon fuel ratio, and the average sulfur level in the fuel stream.

An example desulfurization system including a suitable SCSO reactor and sorbent bed may include one or more of those examples described in U.S. Pat. No. 9,034,527 granted May 19, 2015 to Budge. The entire content of U.S. Pat. No. 9,034,527 is incorporated by reference herein in its entirety.

System 10 may be configured such that the hydrocarbon fuel stream 14 may be selectively passed through passive sorbent bed 16 and/or SCSO reactor and active sorbent bed 22 during operation to remove sulfur from fuel stream 14, which may then be supplied to FCV 12 as a DNG stream. FCV 12 may include one or more electrochemical cells, e.g., in the form of a fuel cell stack, which are used to generate electricity via chemical reaction. FCV 12 may also include one or more sub-systems configured to further process DNG stream 14.

Any suitable fuel cell system including one or more electrochemical cells may be utilized in the present disclosure by FCV 12. Suitable examples include those examples described in U.S. Patent Application Publication No. 2013/0122393 to Liu et al., published May 16, 2013, the entire content of which is incorporated by reference. While U.S. Patent Application Publication No. 2013/0122393 describes one or more example solid oxide fuel cell systems, FCV12 may also include other types of fuel cells, such as, e.g., phosphoric acid, molten carbonate, and/or proton exchange membrane. The electrochemical cells of FCV 12 may include an anode, cathode, and electrolyte, and the fuel cell stack of FCV 12 may include an anode (fuel) side and cathode (oxidant) side. During the operation of fuel cell system 10, an oxidant stream (e.g., in the form of air) may be fed to the cathode side. Similarly, DNG stream 14 may be further processed in one or more hydrocarbon reformers and then fed to the anode side of the fuel cells stack. The hydrocarbon reformers may include pre-reformers for removing higher hydrocarbons from the fuel stream and steam reformers for converting all or a portion of the hydrocarbons to carbon monoxide and hydrogen. The steam required for the reformers may be conveniently obtained by recycling and mixing a portion of the anode side exhaust stream with DNG stream 14.

Passive sorbent bed 16 and SCSO reactor 20/active sorbent bed 22 may be used in any combination with each other to provide a suitable DNG stream for FCV 12 during operation. For example, during start-up (e.g., prior to SCSO reactor 20/active sorbent bed 22 reaching a suitable operating temperature), all or a portion (e.g., substantially all) of hydrocarbon fuel stream 14 may be selectively supplied to passive sorbent bed 16 along flow path 24, flow through passive sorbent bed 16, and then exit passive sorbent bed 16 along flow path 28 as a DNG stream. In some examples, substantially all of fuel stream 14 may be supplied to passive sorbent bed 16, e.g., during heat-up of SCSO reactor and active sorbent bed 22. As shown, the exit stream from passive sorbent bed 16 may optionally be mixed with a portion of hydrocarbon fuel stream 14 that is directed along flow path 26 to not flow through passive sorbent bed 16 and also mixed with oxidant stream 18 (e.g., in the form of air or other suitable oxidant). The mixed stream may be heated by heating module 21 to provide a heated partially desulfurized NG stream that is then supplied to SCSO reactor 20 and active sorbent bed 22 for heat-up of sorbent bed 22, e.g., during start-up. The outlet gas stream from active sorbent bed 22 may be supplied to FCV 12 along flow path 32. Additionally or alternatively, the outlet DNG stream from sorbent bed 22 may be vented, and/or used in other system operations.

Heating module 21 may include any suitable apparatus that heats the mixed stream as described herein. In some examples, heating module 21 may be configured to heat the mixed stream supplied to SCSO reactor 20 to a temperature of about 150 degrees Celsius or greater, preferably in some examples to a temperature of about 250 degrees Celsius to about 350 degrees Celsius. Suitable heating apparatuses may include, e.g., one or more heat exchangers, electric heaters and/or gas-fired in-direct heaters. The stream may be heated so that the catalyst in SCSO reactor 20 is at a sufficient temperature to effect efficient oxidation of the sulfur species.

As shown in FIG. 1, system 10 also allows for substantially all or a portion of hydrocarbon fuel stream 14 to be directed along flow pathway 26 that does not pass through passive sorbent bed 16, e.g., using a suitable configuration of valves, pipes, ducts, and the like, and supplied to SCSO reactor 20 and active sorbent bed 22 for sulfur removal. For example, once active sorbent bed 22 reaches a minimum operating temperature following start-up of system 10 (e.g., a temperature of about 300 degrees Celsius or greater), all or a portion (e.g., substantially all) of hydrocarbon fuel stream 14 may be diverted from flow pathway 24 through passive sorbent bed 16 to flow pathway 26 that does not flow through passive sorbent bed 16 before entering SCSO reactor 20 and active sorbent bed 22 for removal for sulfur from fuel stream 14 to form a DNG stream that is supplied to FCV 12. In this manner, the use of passive sorbent bed 16 to remove sulfur compounds in fuel stream 14 may be reduced (e.g., to minimize the amount of sorbent and/or size of sorbent bed 16) while still allowing for desulfurization of fuel stream 14 while SCSO reactor 20 and active sorbent bed 22 are heating up to operating temperature, e.g., during start-up, and/or while SCSO reactor 20 and active sorbent bed 22 are offline and not generating a desulfurized fuel stream to be supplied to FCV 12, e.g., during maintenance.

In some examples, active sorbent bed 22 may take the form of a multi-layered SCSO sorbent bed to reduce the effective heat-up time. In a two layer sorbent bed, the sorbent in the top half should be more effective for SO₃ removal while the bottom section should be effective for both SO₂ and SO₃ removal. The use of a staged bed approach is preferred because SO₃ is significantly more reactive than SO₂ and can in fact displace adsorbed SO₂. For complete sulfur removal, both beds have to be above a minimum temperature. Since the heat up of active sorbent bed 22 bed proceeds from top to bottom, the use of multiple layer sorbent sets allows for effective sulfur removal when the bottom of the sorbent bed is below the required minimum temperature, thereby reducing the operational heat-up time required. Any suitable number of layers may be used in the multilayer configuration of active sorbent bed 22 to reduce start-up time. In some examples, it is believed a four layer bed could initially reduce the effective start-up time by 50% compared to that of a two-layer bed such as that described above. For example, when sorbent bed 22 is comprised of four layers (layers 1 and 3 are comprised of the “top” sorbent material while layers 2 and 4 are comprised of the “bottom” sorbent material, the required heat-up time to heat one layer of each of the top and bottom sorbent materials may be cut in half.

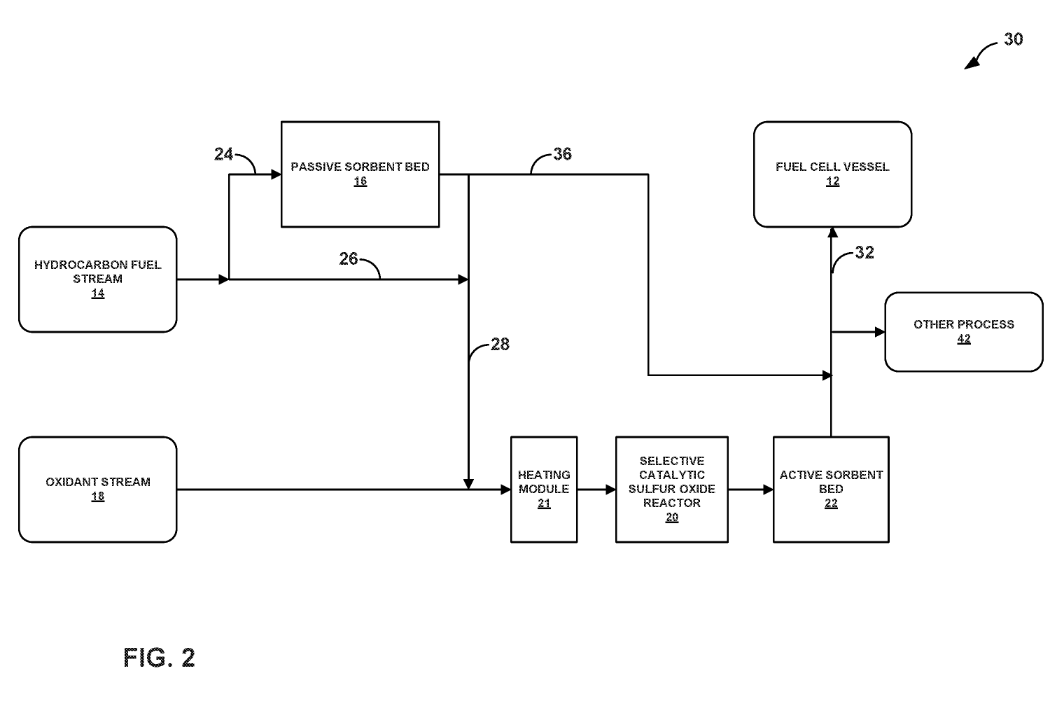

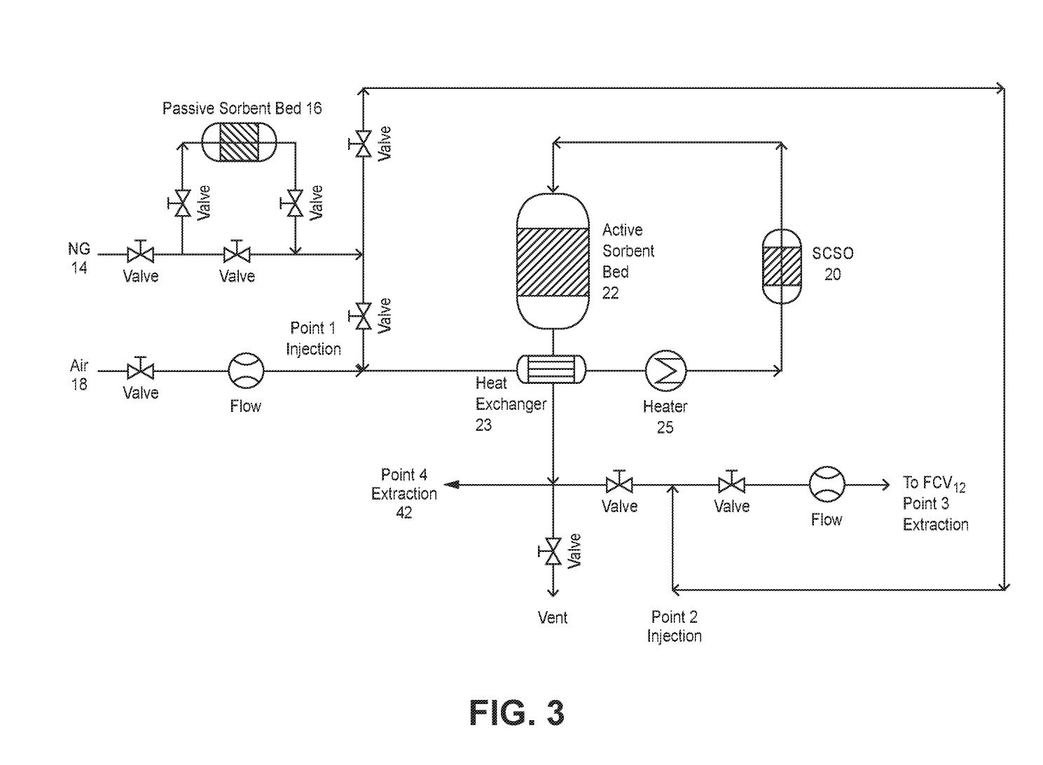

As described such a process may be used advantageously during start-up of system 10. Similarly, such a process may be advantageously used to perform maintenance on SCSO reactor 20 and/or active sorbent bed 22 without shutting down system 10. For example, in such cases, rather than supplying the DNG stream from passive sorbent bed to SCSO reactor 20 and active sorbent bed 22, the DNG stream may not pass through SCSO reactor 20 and active sorbent bed 22 and fed directly to FCV 12 or used in other system operations, e.g., in the system configuration shown in FIGS. 2 and 3. In either case, since passive sorbent bed 16 may be used for only a relatively short period of time, e.g., during start-up or maintenance of SCSO reactor, passive sorbent bed 16 may be smaller in size and contain less sorbent material compared to a system that relied on such a passive sorbent bed 16 for desulfurizing hydrocarbon fuel stream 14 during all operations of system 10.

FIG. 2 is a simplified schematic diagram illustrating another example solid oxide fuel cell system 30 in accordance with an embodiment of the present disclosure. System 30 is substantially similar to that of system 10 and like features are similarly numbered. However, unlike that of system 10, system 30 includes flow path 36 for the DNG gas stream exiting passive sorbent bed 36. As described above, using flow path 36 in such a configuration, the DNG from hydrocarbon fuel stream 14 exiting passive sorbent bed 16 may bypass or otherwise not pass through SCSO reactor 20 and active sorbent bed 22 and be fed directly to FCV 12 and/or other process components 42 of system 30. Additionally, as shown in FIG. 2, the DNG from active sorbent bed 22 may be fed to other process components 42 in addition to, or as an alternative to, FCV 12. Although not shown, system 30 may additionally or alternatively be configured to vent all or a portion of the DNG stream from passive sorbent bed 16 and/or active sorbent bed 22.

Examples of other process components 42 in system 30 that may receive the DNG include homogeneous and catalytic combustion units used to generate heat for the fuel cell system. The DNG from passive sorbent bed 16 and/or active sorbent bed 22 may be delivered to such components 42 in system 30 to generate heat when, for example, demand for DNG by FCV 12 is low-such as during start-up, standby or low-load operations. Thus, DNG can be effectively used during these periods with no or low power generation to heat up or maintain the thermal balances in the fuel cell system and thereby reduce undesirable emissions of pollutants such as hydrocarbons, carbon monoxide and sulfur oxides, by system 30.

FIG. 3 is a schematic diagram illustrating example solid oxide fuel cell system 30 of FIG. 2 in further detail. Like features are similarly numbered. As shown in FIG. 3, hydrocarbon fuel stream 14 is a NG stream and oxidant stream 18 is an air stream. As shown, system 30 includes heat exchanger 23 and heater 25. Heater 25 may be used to heat the mixed fuel-air stream, e.g., to a temperature of about 150 degrees Celsius or greater, but not used during operation once the SCSO reactor 20 and active sorbent bed 22 reach a suitable operating temperature, e.g., a temperature of about 300 degrees Celsius or greater. During normal operation, the heat recuperated in the heat exchanger 23 is sufficient to pre-heat the incoming fuel-air mixture.

As will be apparent from the description, some examples of the disclosure may provide for one or more advantages. For example, in some instances, a fuel processing/desulfurization subsystem in accordance with one or more examples of the disclosure may significantly decrease start-up time, eliminate process hardware and provide an “instant-on” capability for DNG (desulfurized natural gas) through the use of a passive sulfur removal sorbent system. For example, the “instant-on” capability allows the SCSO sorbent bed to be heated up more gradually using only heat generated by the SCSO reactor and to be independent of the time restrictions imposed by FCV-12 demand for DNG. Thus, any additional hardware (blowers, natural gas burners) needed to accelerate the heat-up of the SCSO sorbent bed and the associated control and safety hardware may be eliminated, reducing cost/complexity and improving reliability. As another example, examples of the disclosure may allow for a decrease in emissions during start-up, e.g., due to the “Instant-on” capability that provides for reduced start-up times and no sulfur emissions from the combustion sub-systems needed to heat-up FCV 12.

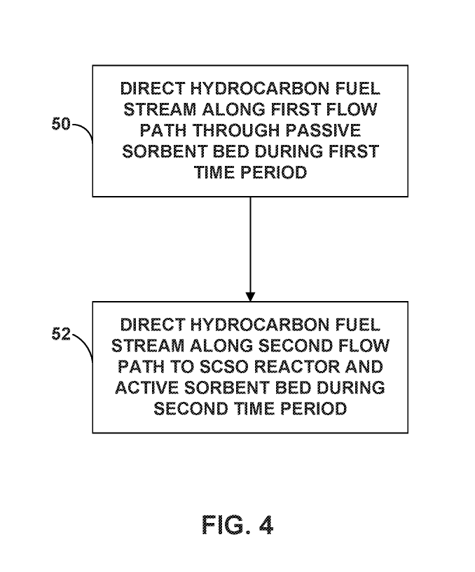

FIG. 4 is a flow diagram illustrating an example technique for operating a fuel cell system including a passive sorbent bed, a SCSO reactor, and an active sorbent bed for desulfurization of a natural gas stream containing one or more sulfur compounds. For ease of illustration, the example technique of FIG. 4 is described with regard to the operation of fuel cell system 10 shown in FIG. 1. However, such techniques may be employed using any suitable fuel cell system, such, e.g., as system 30 of FIGS. 2 and 3 or other fuel cell systems including both a passive sorbent bed and an SCSO reactor/active sorbent bed for desulfurization of a fuel stream (e.g., a natural gas stream).

As shown in FIG. 4, during a first time period, system 10 may be configured to direct hydrocarbon fuel stream 14 along first flow path 24 to supply stream 14 through passive sorbent bed 24 and exiting along flow path 28 as a DNG stream (50). As described above, the DNG stream may be mixed with oxidant stream along flow path 28, heated via heating module 21, supplied to SCSO reactor 20 and active sorbent bed 22, and then supplied to FCV 12 along flow path 32. Additionally or alternatively, the DNG stream exiting passive sorbent bed 16 may directed along a flow path that does not pass through one or more of heating module 21, SCSO reactor 20, and/or active sorbent bed 22, such as, e.g., along flow path 36 in FIG. 2 where the DNG stream exiting passive sorbent bed 16 is fed to FCV 12 and/or other process(es) 42 without passing through heating module 21, SCSO reactor 20, and active sorbent bed 22. In some examples, substantially all of hydrocarbon fuel stream 14 (e.g., all) may be supplied to passive sorbent bed 16 along first flow path 24 rather than along second flow path 26 during the first time period.

During a second time period (e.g., following the first time period according to FIG. 4), system 10 may be configured to direct hydrocarbon fuel stream 14 (e.g., all or substantially all of fuel stream 14) along second flow path 26 rather than being supplied to passive sorbent bed 16. The direction of fuel stream 14 between first flow path 24 and second flow path 26 may be achieved using a three way valve or other suitable mechanisms. Hydrocarbon fuel stream 14 directed along second flow path 26 may be mixed with oxidant stream 18, supplied to SCSO reactor 20 and active sorbent bed 22, and then supplied to FCV 12 along flow path 32. In some examples, the oxidant/hydrogen fuel stream mixture may be heated via heating module 21, while in others the stream is not. In some examples, substantially all of hydrocarbon fuel stream 14 (e.g., all) may be supplied to passive sorbent bed 16 along first flow path 24 rather than along second flow path 26 during the second time period.

In some examples, such as the example process of FIG. 4, the amount of flow in the fuel stream is controlled by the demand from FCV 12 while the flow path (e.g., first flow path 24 versus second control path 26) of fuel stream 14 is controlled by the temperature of active sorbent bed 22. Once active sorbent bed 22 reaches the minimum operating temperature, such as approximately 300 degrees Celsius, the fuel flow 14 may be directed from first flow path 24 to second flow path 26 to bypass passive sorbent bed 16.

In some examples, the first time period may be a start-up time period for system 10 in which passive sorbent bed 16 is employed to desulfurize hydrogen fuel stream 14 while SCSO reactor 20 and/or active sorbent bed 22 are heated up to operating temperature. In such an example, the second time period of FIG. 4 corresponds to when SCSO reactor 20 and active sorbent bed 22 are at or above the operating temperature following the first time period. During the second time period, hydrocarbon fuel stream 14 is directed along flow path 26 rather than flow path 24 such that hydrocarbon fuel stream 14 is not supplied through passive sorbent bed 16.

In some examples, system 10 is operated such that active sorbent bed 22 is heated in two operating modes, e.g., during the first time period. A lower temperature heat-up uses the heating module to heat hydrocarbon fuel stream 14 to a first temperature, such as, e.g., approximately 150 degrees Celsius while fuel stream 14 is direct along first flow pathway 24 and SCSO reactor 20 has not yet been lit-off. The objective of the first heat-up mode is to elevate the temperature of active sorbent bed 22 to or above a threshold temperature, e.g., approximately 55 degrees Celsius, at the active sorbent bed exit to avoid condensation of steam that will be generated after the SCSO is lit-off. Steam is a byproduct of the SCSO reaction, and is typically generated in a quantity that yields a dew point temperature of approximately 55 degrees Celsius in the product gas. However, other dew points are contemplated. In summary, operating mode one may use first fuel flow pathway 24 while heating module 21 heats the fuel stream to the first temperature, e.g., approximately 150 degrees Celsius. System 10 continues to operate in operating mode one until the exit temperature of the active sorbent bed reaches a dew point temperature of the flow exiting active sorbent bed 22 or greater, such as, e.g., approximately 55 degrees Celsius or greater.

Subsequently, system 10 may then operate in operating mode two. Operating mode two permits the SCSO reactor 20 to light-off in order to heat the active sorbent bed 22 to the required operating temperature to effectively desulfurize the received fuel flow with SCSO reactor 20 and active sorbent bed 22. Therefore, during operating mode two, fuel flow 14 is still directed along first flow path 24 to be desulfurized by passive sorbent bed 24 to allow the heat-up of active sorbent bed 22 during normal fuel cell operation. There may be two requirements to light-off the SCSO reactor 20. First, active sorbent bed 22 is at or above operating temperature, e.g., greater than approximately 225 degrees Celsius, and second, the power plant demand for hydrocarbon fuel stream 14 is sufficient to achieve an effective light-off of SCSO reactor 20. In certain phases of the heat-up of the fuel cell power plant, there may be insufficient flow to effectively control light-off of SCSO reactor 20. Thus, before light-off, the control system of system 10 (not shown) must confirm that there is sufficient flow.

System 10 may then operate in operating mode three. In operating mode three, system 10 directs hydrocarbon fuel flow 14 along second fuel flow path 26 when the active sorbent bed exit temperature is at or above operating temperature, e.g., greater than approximately 225 degrees Celsius. For example, the control system may direct fuel flow 14 along second flow path 26 rather than first flow path 24 by energizing a 3-way valve to bypass passive sorbent bed 16 since active sorbent bed 22 is able to effectively desulfurizing hydrogen fuel stream 14.

As described herein, another embodiment of the operating process is the ability of system 10 to switch back to employing passive sorbent bed 16 for desulfurization of hydrocarbon fuel stream 14 while system 10 is operating, e.g., following start-up. For example, if SCSO reactor 20 suffers an operational failure that causes the termination of the air flow to the SCSO reactor 20, a sudden stoppage of DNG being supplied to FCV 12 may cause an emergency shutdown of the fuel cell power plant that would subject the fuel cell to a severe operational temperature transient that presents significant risk to the health of the fuel cell. However, with the availability of passively desulfurized fuel in the event of a failure of the active desulfurization system, the plant can be shut down using a normal cool-down, e.g., during which time DNG is supplied via passive sorbent bed 16 rather than SCSO reactor 20 and active sorbent bed 22. Additionally or alternatively, passive sorbent bed 16 may be employed periodically during operation of system 10 to supply DNG to FCV 12 rather than SCSO reactor 20 and active sorbent 22, e.g., during maintenance of SCSO reactor 20 and/or active sorbent 22, without requiring system 10 to shut down.

Any suitable control system may be used to control the operation of system 10 or any other suitable fuel cell system in the manner described herein. In some examples, suitable temperature sensors and/or flow sensors may be employed to allow for the operation of a fuel cell system to operate as described herein. The control system may employ a control module to control the example processes described herein. In some examples, the control module may include a microprocessor or multiple microprocessors capable of executing and/or outputting command signals in response to received and/or stored data. The control module may include one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. The control module may include computer-readable storage, such as read-only memories (ROM), random-access memories (RAM), and/or flash memories, or any other components for running an application and processing data for controlling operations associated with system 10, system 30 or other suitable system. Thus, in some examples, the controller module may include instructions and/or data stored as hardware, software, and/or firmware within the one or more memories, storage devices, and/or microprocessors. In some examples, controller may control print head 66 using a computer-aided manufacturing (CAM) software package running on a microcontroller.

Various embodiments of the invention have been described. These and other embodiments are within the scope of the following claims.

1. A fuel cell system comprising:
a hydrocarbon fuel stream comprising a sulfur compound;
a passive sorbent bed comprising at least one selective sulfur sorbent configured to remove the sulfur compound from the hydrocarbon fuel stream to form a first desulfurized hydrocarbon stream, wherein the system is configured such that the hydrocarbon fuel stream passes through the passive sorbent bed along a first flow pathway and does not pass through the passive sorbent bed along a second flow pathway, wherein the system is configured such that the hydrocarbon fuel stream is selectively directed along at least one of the first flow pathway or the second flow pathway;
an oxidant stream, wherein the system is configured such that the oxidant stream mixes with at least one of the hydrocarbon fuel stream from the second flow pathway or the first desulfurized hydrocarbon stream from the first flow pathway;
a heating module configured to heat the mixed oxidant and at least one of the hydrocarbon fuel or first desulfurized hydrocarbon streams to a temperature greater than about 150 degrees Celsius;
a selective catalytic sulfur oxidation (SCSO) reactor comprising at least one sulfur oxidation catalyst, wherein the selective catalytic sulfur oxidation reactor is configured to receive and contact the heated mixture of the oxidant stream and the at least one of the hydrocarbon fuel stream or the first desulfurized hydrocarbon fuel stream with the at least one sulfur oxidation catalyst, wherein the at least one sulfur oxidation catalyst is configured to oxidize at least one sulfur-containing compound in the received stream to form an SCSO effluent stream including sulfur oxides;
an active sorbent bed comprising a sulfur oxide sorbent, wherein the active sorbet bed is configured to receive the SCSO effluent stream from the SCSO reactor and remove at least a portion of the sulfur oxides via the sulfur oxide sorbent to form a second desulfurized hydrocarbon stream, and
a solid oxide fuel cell including at least one electrochemical cell, wherein the solid oxide fuel cell is configured to receive at least a portion of the second desulfurized hydrocarbon stream as a fuel source.

2. The fuel cell system of claim 1, wherein the system is configured such that at least a first portion of the first desulfurized hydrocarbon stream from the first flow pathway does not flow through the SCSO reactor.

3. The fuel cell system of claim 2, wherein the first portion of desulfurized hydrocarbon stream does not pass through the solid oxide fuel cell.

4. The fuel cell system of claim 2, wherein the first portion of desulfurized hydrocarbon stream is supplied to the solid oxide fuel cell as the fuel source.

5. The fuel cell system of claim 1, wherein the system is configured such that substantially all of the hydrocarbon fuel stream is directed along the second flow pathway such that the substantially all of the hydrocarbon fuel stream does not pass through the passive sorbent bed when the SCSO reaches a threshold operating temperature.

6. The fuel cell system of claim 1, wherein at least a portion of the second desulfurized hydrocarbon stream does not pass through the solid oxide fuel cell.

7. The fuel cell system of claim 1, wherein the hydrocarbon fuel stream comprises natural gas, and wherein the natural gas includes the sulfur compound.

8. The fuel cell system of claim 1, wherein the oxidant input comprises air.

9. The fuel cell system of claim 1, wherein the active sorbent bed comprises a first layer of sulfur oxide sorbent and second layer of sulfur oxide sorbent, wherein the second layer is downstream from the first layer in the sorbent bed, wherein the first layer includes a sulfur oxide sorbent having a preferential affinity for sulfur trioxide, and wherein the second layer comprises a sulfur oxide sorbent having a preferential affinity for sulfur dioxide.

10. The fuel cell system of claim 1, wherein the active sorbent bed comprises a third layer of sulfur oxide sorbent and fourth layer of sulfur oxide sorbent downstream of the first and second layer, wherein the fourth layer is downstream from the third layer in the sorbent bed, wherein the third layer includes the sulfur oxide sorbent having the preferential affinity for sulfur trioxide, and wherein the fourth layer comprises the sulfur oxide sorbent having the preferential affinity for sulfur dioxide.

11. The fuel cell system of claim 1, wherein the heating module is configured to heat the mixed oxidant and the at least one of the hydrocarbon fuel or first desulfurized hydrocarbon streams to the temperature of about 250 degrees Celsius and about 350 degrees Celsius.

12. A method for operating a fuel cell system, the fuel cell system comprising:
a hydrocarbon fuel stream comprising a sulfur compound;
a passive sorbent bed comprising at least one selective sulfur sorbent configured to remove the sulfur compound from the hydrocarbon fuel stream to form a first desulfurized hydrocarbon stream, wherein the system is configured such that the hydrocarbon fuel stream passes through the passive sorbent bed along a first flow pathway and does not pass through the passive sorbent bed along a second flow pathway, wherein the system is configured such that the hydrocarbon fuel stream is selectively directed along at least one of the first flow pathway or the second flow pathway;
an oxidant stream, wherein the system is configured such that the oxidant stream mixes with at least one of the hydrocarbon fuel stream from the second flow pathway or the first desulfurized hydrocarbon stream from the first flow pathway;
a heating module configured to heat the mixed oxidant and at least one of the hydrocarbon fuel and first desulfurized hydrocarbon streams to a temperature greater than about 150 degrees Celsius;
a selective catalytic sulfur oxidation (SCSO) reactor comprising at least one sulfur oxidation catalyst, wherein the selective catalytic sulfur oxidation reactor is configured to receive and contact the heated mixture of the oxidant stream and the at least one of the hydrocarbon fuel stream or the first desulfurized hydrocarbon fuel stream with the at least one sulfur oxidation catalyst, wherein the at least one sulfur oxidation catalyst is configured to oxidize at least one sulfur-containing compound in the received stream to form an SCSO effluent stream including sulfur oxides;
an active sorbent bed comprising a sulfur oxide sorbent, wherein the active sorbet bed is configured to receive the SCSO effluent stream from the SCSO reactor and remove at least a portion of the sulfur oxides via the sulfur oxide sorbent to form a second desulfurized hydrocarbon stream, and
a solid oxide fuel cell including at least one electrochemical cell, wherein the solid oxide fuel cell is configured to receive at least a portion of the second desulfurized hydrocarbon stream as a fuel source, the method comprising:
directing the hydrocarbon fuel stream along the first flow pathway during a first time period; and
directing the hydrocarbon fuel stream along the second flow pathway during a second time period different from the first time period.

13. The method of claim 12, wherein the system is configured such that at least a first portion of the first desulfurized hydrocarbon stream from the first flow pathway does not flow through the SCSO reactor during the first time period

14. The method of claim 13, wherein the first portion of desulfurized hydrocarbon stream does not pass through the solid oxide fuel cell.

15. The method of claim 13, wherein the first portion of desulfurized hydrocarbon stream is supplied to the solid oxide fuel cell as the fuel source.

16. The method of claim 12, wherein the system is configured such that substantially all of the hydrocarbon fuel stream is directed along the second flow pathway during the second time period such that the substantially all of the hydrocarbon fuel stream does not pass through the passive sorbent bed when the SCSO reaches a threshold operating temperature.

17. The method of claim 12, wherein at least a portion of the second desulfurized hydrocarbon stream does not pass through the solid oxide fuel cell.

18. The method of claim 12, wherein the hydrocarbon fuel stream comprises natural gas, and wherein the natural gas includes the sulfur compound.

19. The method of claim 12, wherein the oxidant input comprises air.

20. The method of claim 12, wherein the active sorbent bed comprises a first layer of sulfur oxide sorbent and second layer of sulfur oxide sorbent, wherein the second layer is downstream from the first layer in the sorbent bed, wherein the first layer includes a sulfur oxide sorbent having a preferential affinity for sulfur trioxide, and wherein the second layer comprises a sulfur oxide sorbent having a preferential affinity for sulfur dioxide.

21. The method of claim 12, wherein the active sorbent bed comprises a third layer of sulfur oxide sorbent and fourth layer of sulfur oxide sorbent downstream of the first and second layer, wherein the fourth layer is downstream from the third layer in the sorbent bed, wherein the third layer includes the sulfur oxide sorbent having the preferential affinity for sulfur trioxide, and wherein the fourth layer comprises the sulfur oxide sorbent having the preferential affinity for sulfur dioxide.

22. The method of claim 12, wherein the heating module is configured to heat the mixed oxidant and the at least one of the hydrocarbon fuel or first desulfurized hydrocarbon streams to the temperature of about 250 degrees Celsius and about 350 degrees Celsius.

23. The method of claim 12, wherein the first time period is before the second time period.

24. The method of claim 12, wherein the second time period is before the first time period.
